(19) United States
(12) Patent Application Publication
(10) Pub. No.: US 2010/0153614 A1
(43) Pub. Date: Jun. 17, 2010

(54) INFORMATION TRANSMISSION SYSTEM, INFORMATION SENDING DEVICE AND INFORMATION RECEIVING DEVICE

(75) Inventors: Rie USHIGOME, Saitama (JP); Masayuki ABE, Saitama (JP); Ichiro KAWAZOME, Saitama (JP); Kazuya EDOGAWA, Saitama (JP); Satoshi MINOWA, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/432,526

(22) Filed: Apr. 29, 2009

(30) Foreign Application Priority Data
Dec. 17, 2008 (JP) 2008-321392

(51) Int. Cl. G06F 13/00

(52) U.S. Cl. 710/316

(57) ABSTRACT

In an information transmission system, an information sending device includes a generating unit that generates instruction information that instructs switching between operation states of each of transmission paths and a sending unit that apportions information to be transmitted to transmission paths that have been set in an effective state and sends the instruction information a transmission path. An information receiving device includes a receiving unit that receives information transmitted through the transmission paths and a restoring unit that restores information to be transmitted based on the information transmitted by the transmission paths that have been set in the effective state in the instruction information received through the transmission path.

### CROSS-REFERENCE TO RELATED APPLICATIONS

This application is based on and claims priority under 35 USC 119 from Japanese Patent Application No. 2008-321392 filed Dec. 17, 2008.

### BACKGROUND

1. Technical Field

The present invention relates to an information transmission system, an information sending device and an information receiving device.

2. Related Art

Conventionally, PCI Express is known as a serial transmission interface directed to personal computers that replaces a PCI bus. This PCI Express carries out connection between devices that carry out transmission of data, with a pair of serial transmission paths (a so-called lanes). In a case where high data bandwidth between devices is demanded, it is possible to achieve high-speed transmission of data by providing plural pairs of lanes in parallel (a link).

### SUMMARY

According to an aspect of the invention, there is provided an information transmission system including: an information sending device and an information receiving device, the information sending device including: a generating unit that generates instruction information that instructs switching between operation states of each of a plurality of transmission paths, the transmission paths being provided in parallel and individually capable of being switched between a plurality of operation states including an effective state in which data transmission is available and a dormant state in which data transmission is unavailable; and a sending unit that apportions and information to be transmitted to transmission paths that have been set in the effective state in the instruction information generated by the generating unit and sends the instruction information to a transmission path among the transmission paths that have been set in the effective state, and the information receiving device including: a receiving unit that receives information transmitted through the transmission paths; and a restoring unit that restores information to be transmitted based on the information transmitted by the transmission paths that have been set in the effective state in the instruction information received through the transmission path by the receiving unit.

### BRIEF DESCRIPTION OF THE DRAWINGS

An exemplary embodiment of the present invention will be described in detail based on the following figures, wherein:

FIG. 1 is a block diagram showing a schematic configuration of an information transmission system 10 according to an exemplary embodiment;

FIGS. 2A and 2B are conceptual diagrams showing a configuration of physical layers of a control section according to the exemplary embodiment; and

FIGS. 3A and 3B are views showing, in frame format, a flow when operation states are switched, according to the exemplary embodiment.

### DETAILED DESCRIPTION

An exemplary embodiment of the present invention will be described in detail below with reference to the drawings. In the following, a case where two devices are connected by PCI Express will be explained in order to simplify the explanation.

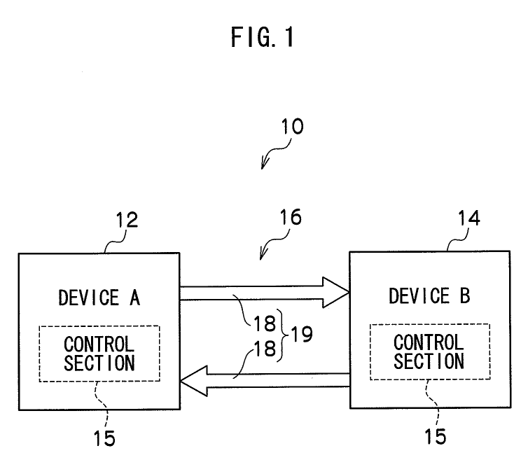

In FIG. 1, an overall schematic configuration of an information transmission system 10 according to the present exemplary embodiment is shown.

As shown in this drawing, in the information transmission system 10, a device 12 and a device 14 are connected, point to point, by a PCI Express 16. The devices 12 and 14 each have built therein a control section 15 such as an LSI for PCI Express control.

The PCI Express 16 connects the device 12 and the device 14 by a pair of transmission paths 18 (so-called lanes 19) which are capable of transmission of data at 2.5 Gbps or 5.0 Gbps, and by providing plural pairs of lanes 19 in parallel, it is possible to achieve high-speed data transmission between the devices.

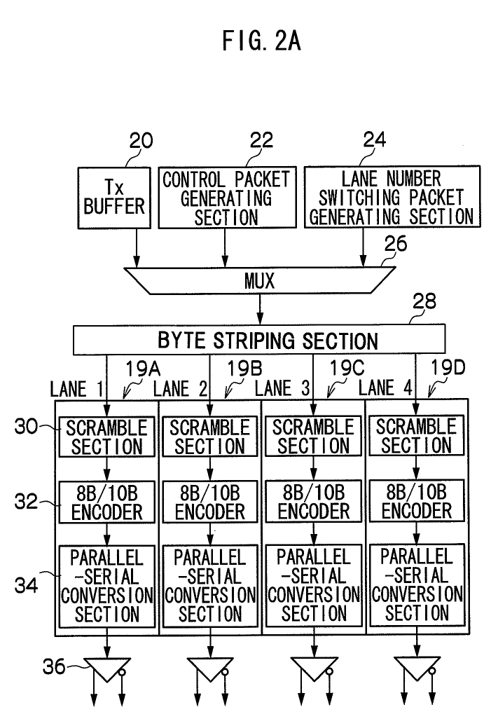

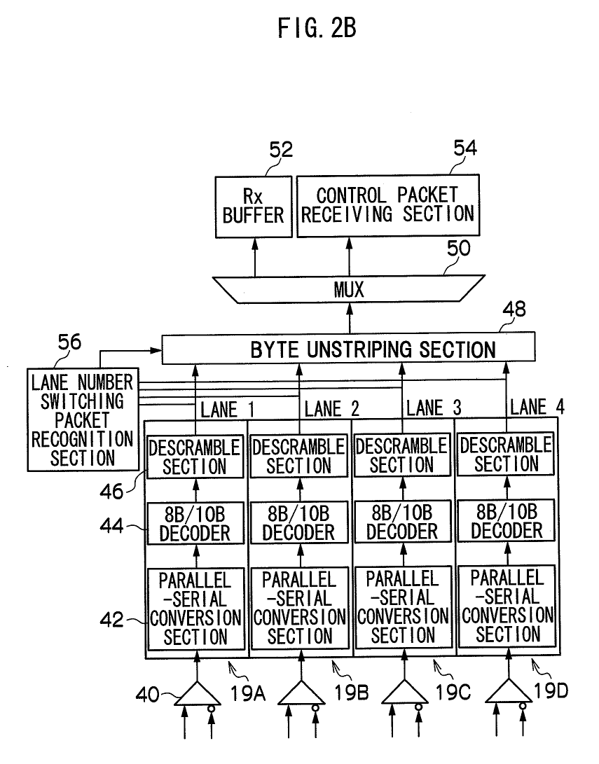

In FIGS. 2A and 2B, conceptual diagrams showing a configuration of physical layers of the control section 15 according to the present exemplary embodiment are shown. FIG. 2A is a configuration of a sending side that sends data to the transmission paths 18. FIG. 2B is a configuration of a receiving side that receives data from the transmission paths 18.

As shown in FIG. 2A, at the sending side that sends data, a Tx buffer 20 that stores information to be transmitted, a control packet generating section 22 that generates various control packets that control the physical layers, and a lane number switching packet generating section 24 that generates a lane number switching packet that instructs switching between operation states of the lanes 19 are provided.

At the Tx buffer 20, transaction layer packets (TLP) and data link layer packets (DLLP) generated at a data link layer are stored.

The Tx buffer 20, the control packet generating section 22 and the lane number switching packet generating section 24 are connected to a multiplexer (MUX) 26. The multiplexer 26 selectively outputs data inputted from the Tx buffer 20, the control packet generating section 22 and the lane number switching packet generating section 24.

At the output side of the multiplexer 26, a byte striping section 28 is connected.

The byte striping section 28 apportions data that is to be sent, to the lanes 19, by byte unit. In the present exemplary embodiment, a case where four lanes 19A through 19D are provided is shown. At each of the lanes 19A through 19D, a scramble section 30, an 8B/10B encoder 32, a parallel-serial conversion section 34 and a differential driver 36 are provided. The 8B/10B encoder 32 is connected to an output side of the scramble section 30. The parallel-serial conversion section 34 is connected to an output side of the 8B/10B encoder 32. The differential driver 36 is connected to an output side of the parallel-serial conversion section 34.

The scramble section 30 randomizes a pattern of data that has been input from the byte striping section 28 in accordance with a predetermined conversion rule and prevents EMI (electromagnetic interference) from being concentrated at a specific frequency.

The 8B/10B encoder 32 carries out 8B/10B encoding with respect to the data that has been randomized at the scramble section 30. In the 8B/10B encoding, since clock information is incorporated within the data, it becomes unnecessary to provide a separate clock signal for transmission of the data. As a result, wiring routing becomes easy, and no time difference is generated between a clock and the data.

The parallel-serial conversion section 34 converts the data that has been encoded at the 8B/10B encoder 32 into serial bit strings and outputs the same to the differential driver 36.

At the differential driver 36, the inputted digital bit strings are converted into analog differential signals and outputted.

As shown in FIG. 2B, at each of the lanes 19A through 19D on the receiving side that receives data, a differential receiver 40, a serial-parallel conversion section 42, an 8B/10B decoder 44 and a descramble section 46 are provided. The serial-parallel conversion section 42 is connected at an output side of the differential receiver 40. The 8B/10B decoder 44 is connected at an output side of the serial-parallel conversion section 42. The descramble section 46 is connected at an output side of the 8B/10B decoder 44.

Transitions of 0→1 and 1→0 are generated at a constant frequency in the serial bit strings that have been subjected to 8B/10B encoding at the 8B/10B encoder 32 on the sending side.

The differential receiver 40 carries out clock data recovery on the received analog differential signals to separate the clock and the data and reproduce the clock, and carries out conversion into digital serial data.

The serial-parallel conversion section 42 converts, into parallel bit strings, the serial data that has been converted at the differential receiver 40, and outputs this to the 8B/10B decoder 44.

The 8B/10B decoder 44 carries out 8B/10B decoding with respect to the parallel data that has been converted at the serial-parallel conversion section 42.

The descramble section 46 removes the scrambling carried out with the aforementioned predetermined conversion rule, from the data that has been decoded at the 8B/10B decoder 44.

At the output side of the descramble sections 46, a byte unstriping section 48 is connected. The data from which the scrambling has been removed is inputted to the byte unstriping section 48.

The byte unstriping section 48 restores the data that has been apportioned to the lanes 19A through 19D to one data string. At an output side of the byte unstriping section 48, a multiplexer (MUX) 50 is connected. At an output side of the multiplexer 50, an Rx buffer 52 that stores the transmitted information and a control packet receiving section 54 that receives various control packets that control the physical layers are provided.

The various control packets that have been restored by the byte unstriping section 48 are outputted to the control packet receiving section 54 via the multiplexer 50. The transaction layer packets (TLP) and digital link layer packets (DLLP) are stored in the Rx buffer 52 via the multiplexer 50.

At the lanes 19A through 19D on the receiving side which receives the data, a lane number switching packet recognition section 56 that recognizes lane number switching packets that have been transmitted through the lanes 19A through 19D is provided. The lane number switching packet recognition section 56 recognizes lane number switching packets that have been transmitted through the lanes 19A through 19D. The byte unstriping section 48 restores, to one data string, the data that has been transmitted through those of the lanes 19A through 19D that have been set in the effective state, based on the recognition result by the lane number switching packet recognition section 56.

Next, operation of the information transmission system 10 according to the present exemplary embodiment will be explained.

First, a flow of ordinary data transmission will be briefly explained.

The PCI Express 16 according to the present exemplary embodiment carries out transmission of data between devices by utilizing packets and carries out flow control so that overflow and underflow are not generated at a buffer on a sending destination side.

At the Tx buffer 20, transaction layer packets (TLP) and data link layer packets (DLLP) that have been generated at a data link layer and a transaction layer superordinate to the physical layers is stored.

The data that has been stored in the Tx buffer 20 is read out to the byte striping section 28 via the multiplexer 26. The data that has been read out is apportioned, by byte unit, to the lanes 19 that are capable of being utilized, by the byte striping section 28.

At the lanes 19 at the data sending side, scrambling (randomization), 8B/10B encoding and parallel-serial conversion are carried out by the scramble section 30, the 8B/10B encoder 32 and the parallel-serial conversion section 34 with respect to the data that has been apportioned to the lanes 19, and the data is converted to analog differential signals at the differential driver 36 and outputted.

At the receiving side, the differential signals that have been transmitted through the respective transmission paths 18 are received and converted to digital data at the differential receiver 40, and serial-parallel conversion, 8B/10B decoding and removal of scrambling are carried out by the serial-parallel conversion section 42, the 8B/10B decoder 44 and the descramble section 46.

The data that has been apportioned to the lanes 19A through 19D is restored to one data string by the byte unstriping section 48 and stored at the Rx buffer 52 via the multiplexer 50.

Next, a flow when operation states of the transmission paths 18 are switched will be explained.

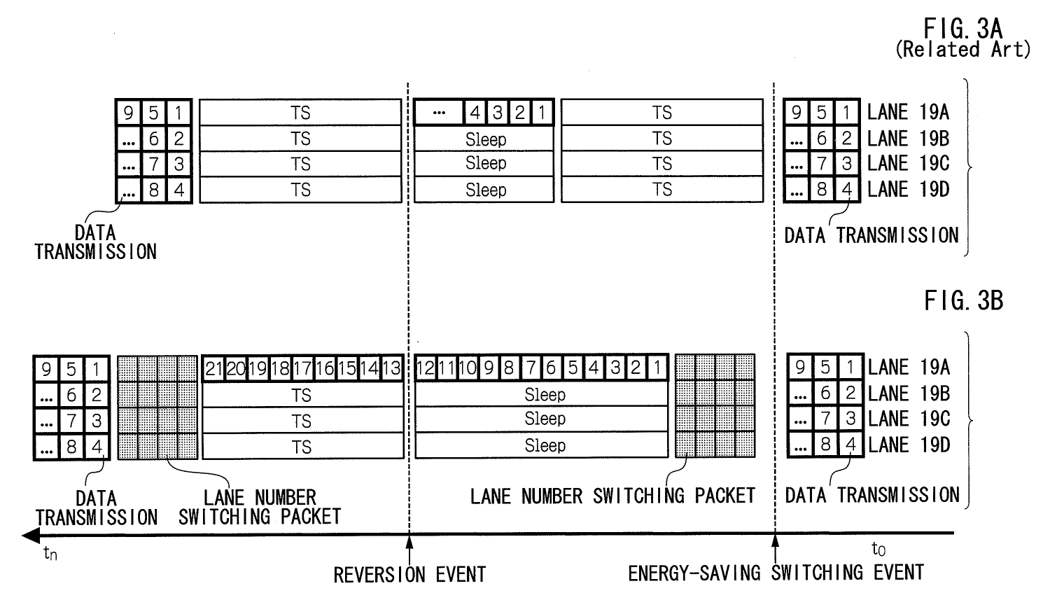

In FIGS. 3A and 3B, a flow when operation states are switched is shown in frame format. FIG. 3B is a flow relating to the PCI Express 16 according to the present exemplary embodiment. FIG. 3A shows a flow relating to conventional PCI Express for the purpose of comparison.

Conventionally, in PCI Express, due to managing of power states, plural states are provided as operation states, such as an L0 state (effective state) in which data transmission is available, an L0ₛ state (dormant state) in which power consumption is reduced and data transmission is unavailable, an L1 state (dormant state) in which power consumption is reduced even more than in the L0ₛ state, and an L2 state (dormant state) in which even operation of the differential driver 36, differential receiver 40 and the like is stopped. In the PCI Express 16 according to the present exemplary embodiment as well, due to managing of power states by the control section 15, it is possible to set various operation states in the same manner as conventionally.

At the time of switching to an energy-saving mode (time of energy-saving switching event occurrence), the lane number switching packet generating section 24 generates a lane number switching packet instructing switching of lanes 19B through 19D to a dormant state.

When the byte striping section 28 recognizes the generated lane number switching packet, the byte striping section 28 changes the number of the lanes 19 that are set in the effective state in accordance with a command to leave the one lane designated in the lane number switching packet and set the other lanes in the dormant state and controls the supply of power to the transmission paths 18 of the lanes 19 for which the dormant state has been instructed to set them in the dormant state, and also sends the lane number switching packet to one or more of the lanes 19 that have been set in the effective state. As a result, the lane number switching packet is sent to the receiving side. Thereafter, the byte striping section 28 apportions and sends the information to be transmitted to the lanes 19 that have been set in the effective state.

At the receiving side, the lane number switching packet recognition section 56 recognizes the lane number switching packet. The byte unstriping section 48 restores, to one data string, the data that is transmitted through the lanes 19 that have been set in the effective state, based on the recognition result by the lane number switching packet recognition section 56.

As shown in FIG. 3B, when an energy-saving switching event (for example, a case where an event occurs in which an information transmission device has been in an idling state for a predetermined time period) is detected, a lane number switching packet that instructs switching between operation states per each lane 19 is sent. As a result, at least one of the lanes may be set in the effective state (an active state), and the other lanes 19 may be set in the dormant state, without executing a training sequence (TS).

In contrast with this, in conventional PCI Express, when an energy-saving switching event is detected, waiting time in a transition to a power-saving state from an ordinary state is long because a training sequence is executed at all of the lanes, as shown in FIG. 3A.

On the other hand, at the time of reversion to the ordinary mode from the energy-saving mode (time of reversion event occurrence), the byte striping section 28 executes a training sequence at the lanes 19B through 19D which have been in the dormant state. After the lanes 19B through 19D have completed the training sequence, the lane number switching packet generating section 24 generates a lane number switching packet that instructs switching of the lanes 19B through 19D to the effective state.

When the byte striping section 28 recognizes the generated lane number switching packet, the byte striping section 28 changes the number of the lanes 19 that are in the effective state in accordance with the recognition result and sends the lane number switching packet to a lane 19 that has been set in the effective state. As a result, the lane number switching packet is sent to the receiving side. Thereafter, the byte striping section 28 apportions and sends the information to be transmitted to the lanes 19 that have been set in the effective state.

At the receiving side, the lane number switching packet recognition section 56 recognizes the lane number switching packet. The byte unstriping section 48 restores, to one data string, the data that has been transmitted through the lanes 19 that have been set in the effective state, based on the recognition result by the lane number switching packet recognition section 56.

As a result, since it becomes unnecessary, at the time of reversion, to execute a training sequence (TS) at the lanes 19 that were originally in the effective state, the waiting time in the transition to the ordinary state from the power-saving state is shortened. By sending the lane number switching packet after training sequence execution at the time of reversion, data transmission becomes available at all of the lanes.

In contrast with this, in conventional PCI Express, waiting time in a transition to the ordinary state from the power-saving state is long because the training sequence is executed at all of the lanes when reversion to the ordinary state from the power-saving state is carried out, as shown in FIG. 3A.

It should be noted that, in the aforementioned FIG. 3B, although a case where the lane number switching packet is generated after completion of the training sequence at the lanes 19B through 19D has been explained, the present invention is not limited thereto. For example, a configuration may be provided in which the lane number switching packet is generated during execution of the training sequence and sent via the lane 19A which is in the effective state. In this case, a configuration may be provided in which transmission of data is started from lanes 19 for which the training sequence has been completed, or a configuration may be provided in which transmission of data is started in parallel from the point in time when the training sequence of all of the lanes 19 has been completed.

In the aforementioned exemplary embodiment, although the case of a configuration in which the device 12 and the device 14 are connected in the information transmission system 10 has been explained, the present invention is not limited thereto. For example, plural devices may be connected, point to point or via switches, to one device.

In the aforementioned exemplary embodiment, although a case where plural devices are connected by PCI Express has been explained, the present invention is not limited thereto. It is possible to apply the present invention to any information transmission system, as long as it is an information transmission system in which plural transmission paths, whose operation states are capable of being changed, are connected in parallel to transmit data between plural devices.

Aside from this, the configuration of the information transmission system 10 explained in the aforementioned exemplary embodiment (refer to FIGS. 1, 2A and 2B) is one example, and appropriate modification is possible within a range that does not depart from the gist of the present invention.

Furthermore, the flow at the time of switching the operation states explained in the aforementioned exemplary embodiment (refer to FIGS. 3A and 3B) is also one example, and it goes without saying that appropriate modification is possible within a range that does not depart from the gist of the present invention.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. An information transmission system comprising:
an information sending device and an information receiving device,
the information sending device comprising:
a generating unit that generates instruction information that instructs switching between operation states of each of a plurality of transmission paths, the transmission paths being provided in parallel and individually capable of being switched between a plurality of operation states including an effective state in which data transmission is available and a dormant state in which data transmission is unavailable; and
a sending unit that apportions and information to be transmitted to transmission paths that have been set in the effective state in the instruction information generated by the generating unit and sends the instruction information to a transmission path among the transmission paths that have been set in the effective state, and
the information receiving device comprising:
a receiving unit that receives information transmitted through the transmission paths; and
a restoring unit that restores information to be transmitted based on the information transmitted by the transmission paths that have been set in the effective state in the instruction information received through the transmission path by the receiving unit.

2. The information transmission system of claim 1, wherein at least one of the information sending device and the information receiving device further comprises a switching unit that carries out switching between the operation states of the transmission paths such that each of the transmission paths is placed in the operation state instructed in the instruction information.

3. The information transmission system of claim 2, wherein:
each of the transmission paths is PCI Express serial bus, and
the switching unit carries out switching between the operation states of the transmission paths without carrying out a training sequence.

4. The information transmission system of claim 2, wherein the switching unit controls power supply to transmission paths that are put in the dormant state and provides the instruction information to the transmission path among the transmission paths that have been set in the effective state, based on the instruction information.

5. The information transmission system of claim 2, wherein the switching unit comprises a byte striping unit that apportions the information to be transmitted to the transmission paths that have been set in the effective state, by byte unit.

6. The information transmission system of claim 5, wherein the restoring unit comprises a byte unstriping unit that restores the information to be transmitted based on the information transmitted through the transmission paths that have been put in the effective state.

7. The information transmission system of claim 1, wherein:
the receiving device further comprises a recognition unit that recognizes the instruction information; and
the restoring unit restores the information to be transmitted based on the information transmitted by the transmission paths that have been set in the effective state, based on the recognition result of the recognition unit.

8. The information transmission system of claim 1, wherein, when a transmission path that was in the dormant state reverts to the effective state, a training sequence is executed at the transmission path, and the generating unit generates new instruction information.

9. An information sending device comprising:
a generating unit that generates instruction information that instructs switching between operation states of each of a plurality of transmission paths, the transmission paths being provided in parallel and individually capable of being switched between a plurality of operation states including an effective state in which data transmission is available and a dormant state in which data transmission is unavailable; and
a sending unit that apportions and information to be transmitted to transmission paths that have been set in the effective state in the instruction information generated by the generating unit and sends the instruction information to a transmission path among the transmission paths that have been set in the effective state.

10. An information receiving device comprising:
a receiving unit that receives information transmitted through a plurality of transmission paths that are provided in parallel and are individually capable of being switched between a plurality of operation states including an effective state in which data transmission is available and a dormant state in which data transmission is unavailable, and in which instruction information that instructs switching between operation states of the transmission paths is sent to a transmission path among the transmission paths; and
a restoring unit that restores the information to be transmitted based on the information transmitted by transmission paths that have been set in the effective state in the instruction information received through the transmission path by the receiving unit.
